(19) United States
(12) Patent Application Publication
(10) Pub. No.: US 2016/0349799 A1
(43) Pub. Date: Dec. 1, 2016

(54) Portable Terminal With Controllable Display Position and Display Method Thereof

(71) Applicant: SHANGHAI HUAQIN TELECOM TECHNOLOGY CO., LTD, Shangghai (CN)

(72) Inventors: Guowang Jiang, Shanghai (CN); Yufeng Zhao, Shanghai (CN)

(73) Assignee: Huaqin Telecom Technology Co., Ltd., Shanghai (CN)

(21) Appl. No.: 15/104,922

(22) PCT Filed: Oct. 1, 2014
(86) PCT No.: PCT/CN2014/088073

§ 371 Date: Jun. 15, 2016

(30) Foreign Application Priority Data
Feb. 12, 2014 (CN) 201410049181.7

(51) Int. Cl. G06F 1/16; G06F 3/01

(52) U.S. Cl. CPC G06F 1/1652; G06F 3/017; G06F 3/014

(57) ABSTRACT

The present invention provides a potable terminal with controllable display position and a display method thereof. The portable terminal comprises a portable terminal body, a display, a processor and a gravity acceleration sensor, wherein the display, the processor and the gravity acceleration sensor are arranged on the portable terminal body. The display is a curved-surface display or a flexible display with a plurality of display areas. Both the display and the gravity acceleration sensor are in communication connection with the processor. The processor controls the display areas of the display according to data detected by the gravity acceleration sensor. The portable terminal of the present invention has simple structure, can ensure that the display areas of the display always face upwards or face towards the eyes of a user, and is convenient to use.

### CROSS-REFERENCE TO RELATED APPLICATIONS

The present application is the U.S. national stage application of International Application PCT/CN2014/088073, filed Oct. 1, 2014, which international application was published on Aug. 20, 2015, as International Publication WO2015/120726. The International Application claims priority of Chinese Patent Application No. 201410049187, filed Feb. 12, 2014, the contents of which are incorporated herein by reference in their entireties.

### FIELD OF INVENTION

The present invention relates to a portable terminal, especially to a portable terminal with controllable display position and a display method thereof.

### PRIOR ARTS

In recent years, thanks to the development and popularization of OLED (organic light-emitting diode), in addition to flat shaped display, the artisan can also form a display with curved shape or a flexible display which can be freely bent. Chinese patent 201310334937 discloses a flexible organic light-emitting diode display and a manufacturing method thereof, for absorbing a stress occurring as the flexible organic light-emitting diode display is being bent, so as to prevent electrodes of the flexible manic light-emitting diode display from being broken due to the action of the stress and effecting the display quality. The display with curved shape or the flexible display extends the operation status of a display and enlarges the application scope thereof.

At present, the portable terminal becomes a popular light-type data communication terminal. If the portable terminal uses the above curved shape or the flexible display, the display can be arranged on the entire periphery of the portable terminal, such as watch-type portable terminal which is easy for user to wear. However, when the display arranged on the entire periphery of the portable terminal displays content, the content on the hand hack cannot be viewed. Furthermore, because the watch-type portable terminal is often shaking with the wrist movement, the desired content may be displayed on the hand back and cannot be viewed.

Therefore, a portable terminal is required which can control the display position to face the user all the time.

### CONTENT OF THE PRESENT INVENTION

In view of the above defects in the prior art, the present invention intends to provide a portable terminal with controllable display position and a display method thereof to solve the existing technical problem as above.

To achieve the above purpose and other relevant purposes, the present invention provides a portable terminal with controllable display position comprising: a portable terminal body, a display arranged on the portable terminal body, a processor and a gravity acceleration sensor. The display is a curved surface display or a flexible display with a plurality of display areas, and both the display and the gravity acceleration sensor are in communication connection with the processor. The processor controls the display areas of the display according to the data detected by the gravity acceleration sensor.

The present invention further provides a display method of the portable terminal comprising: monitoring an orientation change of the terminal in real time by the gravity acceleration sensor arranged inside the portable terminal; when the change of terminal position is detected, determining the direction and angle of the terminal rotation according to the recorded change value on three directions of the gravity acceleration sensor; re-determining the center of the display areas on the display of the portable terminal according to the direction and angle of the terminal rotation; and displaying content on the display based on the center of the display areas.

As above, the portable terminal with controllable display position and the display method thereof of the present invention detects the orientation of the terminal in real time by the gravity acceleration sensor and delivers the detected data to the processor, thus the processor controls the display areas on the display such that the display areas are enabled to face upwardly or face the user's eyes all the time. The present invention has simple structure, can be easily manufactured and brings convenience to the user.

### BRIEF DESCRIPTION OF THE DRAWINGS

FIG. 1 is a structural representation of the portable terminal with controllable display position of the present invention.

FIG. 2 is a block diagram representing various functional modules inside the portable terminal with controllable display position of the present invention.

FIG. 3 is a status diagram of the gravity acceleration sensor under the horizontal orientation.

FIG. 4 is a status diagram of the gravity acceleration sensor under orientation in motion.

FIG. 5 represents the changes of the display areas of the portable terminal with controllable display position under orientation in motion.

### DETAILED DESCRIPTION OF THE PREFERRED EMBODIMENT

Specific embodiments as below illustrate operation mode of the present invention. Those skilled in the art can easily understand other advantages and effects of the present invention from these embodiments.

See FIG. 1 to FIG. 5, it should be noted that the structures, scales, sizes shown in these figures are merely used for illustration to help those skilled in the art to understand the principle of the present invention, not for defining the scope of the present invention. Any structural modification, scale change or size adjustment will fall into the scope of the present invention without deviating the principle of the present invention. Meanwhile, the words “upper”, “low”, “left”, “right”, “mid” and “a” in the description arc also used for illustration, not for defining the scope of the present invention. Any change or adjustment of the positional relations, without substantially change the principle of the present invention, should be deemed as fall into the scope of the present invention.

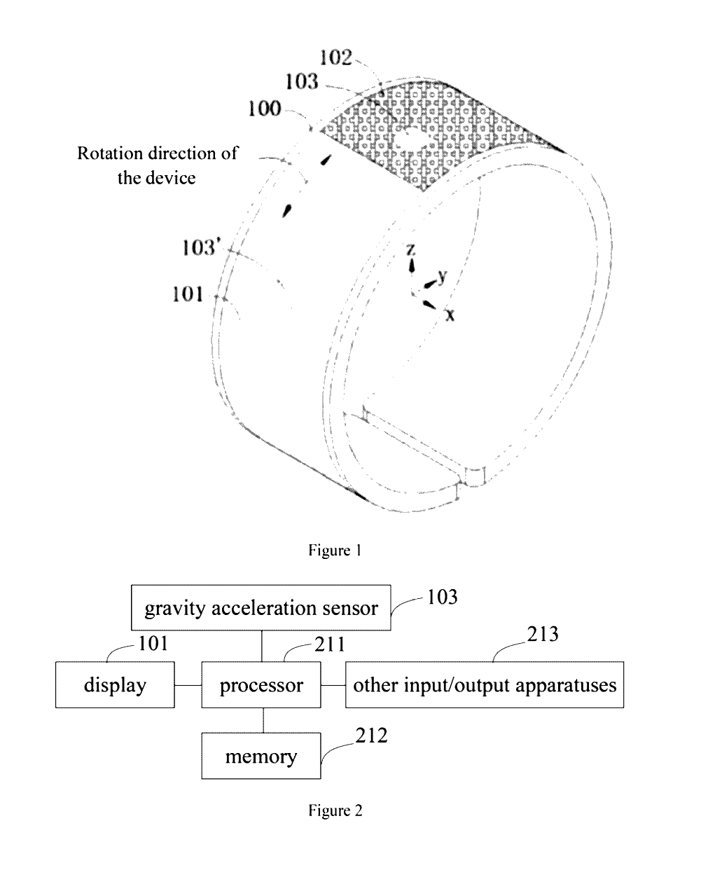

The present invention provides a portable terminal with controllable display position. The portable terminal of the present embodiment has an annular structure, like a wearable watch. It comprises, as shown in FIG. 1 and FIG. 2, a portable terminal body 100, a display 101 arranged on the portable terminal body 100, a processor 211 and a gravity acceleration sensor 103. The display 101 is a curved surface display or a flexible display with a plurality of display areas, and both the display 101 and the gravity acceleration sensor 103 are in communication connection with the processor 211. The processor 211 controls the display areas of the display according to data detected by the gravity acceleration sensor 103. Inside the portable terminal of the present invention, the gravity acceleration sensor is provided. The gravity acceleration sensor monitors whether the portable terminal rotates. If the portable terminal rotates, the gravity acceleration sensor transmits the detected data to the processor, and the processor processes the data and controls the display to change the display areas of the display, such that the display areas are enabled to face upwardly or face the user.

A memory 212 is further arranged on the portable terminal body 100 and the memory 212 is connected to the processor 211. The gravity acceleration sensor 103 attaches to the motherboard by means of SMT (surface mount technology). The gravity acceleration sensor 103 is connected to the processor 211 via signal line or wireless connection. The wireless connection can be any one of the follows: Bluetooth RE technology, communication protocol described in IEEE 802.11 (including any version of IEEE 802.11), ZigBee technology or other wireless connection.

The processor 211 sets operation environment of the portable terminal, holds the information thereof, makes the portable terminal operate steadily, and promotes data input/output exchange between all of units in the portable terminal. Furthermore, the processor 211 is capable of processing the signal of the gravity acceleration sensor (G-sensor) 103 and representing the corresponding results on the display 101.

The display 101 is a spontaneous lighting display made from OLED to reduce power consumption. The display can be a flexible display or a curved surface display and can fit a semi-circle or a circle. The display can represent specified display areas 102 according to preset condition in use (see FIG. 1).

The method for displaying the position (display areas) of the portable terminal includes the following steps:

S1: monitoring an orientation change of the terminal in real time by the gravity acceleration sensor arranged inside the portable terminal;

S2: when the change of terminal position detected, determining the direction and angle of the terminal rotation according to the recorded change value on three directions of the gravity acceleration sensor;

S3: re-determining the center of the display areas on the display of the portable terminal according to the direction and angle of the terminal rotation; and displaying content on the display based on the center of the display areas.

Wherein the specific operation of step S2 includes:

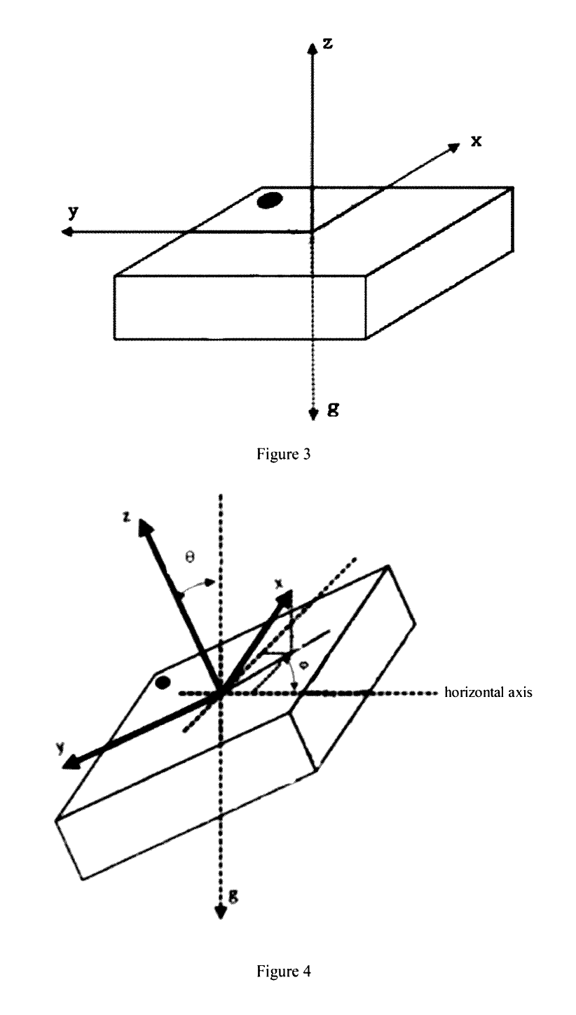

The gravity acceleration sensor 103 includes vectors of three dimensions x/y/z, and outputs the values of gravity and acceleration, and feedbacks the information to the processor 211. In the present embodiment, the original position of the gravity acceleration sensor 103 is horizontal position. As shown in FIG. 3, for the gravity acceleration sensor 103, the gravity value along x direction is ±0 g, that along y direction is ±0 g and that along z direction is ±1 g.

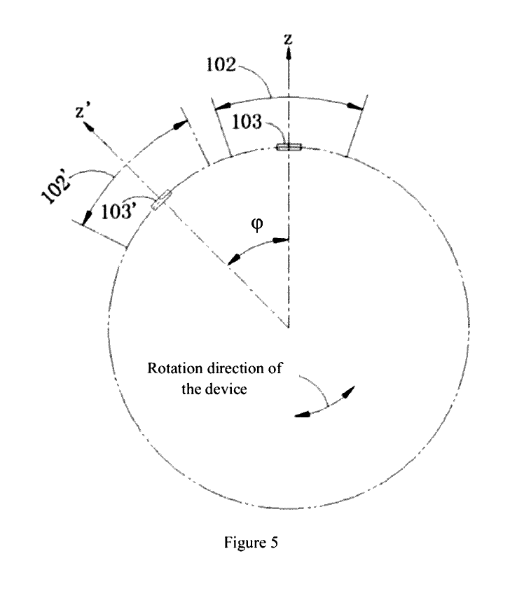

When the portable terminal rotates along the rotation direction as shown in FIG. 1, the portable terminal uses the gravity acceleration sensor 103 to detect the orientation thereof. As shown in FIG. 4, decomposing in real time the gravity acceleration into acceleration on x, y, z directions in three-dimensional space, i.e. acc_x, acc_y, acc_z, and transmitting the detected data to the processor 211.

The processor 211 calculates the status of the gravity acceleration sensor according to the data detected by the gravity acceleration sensor, i.e. calculating slope angle on x\y directions and slope angle on z direction of the gravity acceleration sensor. The slope angle on x\y direction denotes the angle vertically projecting on the surface of the gravity acceleration sensor with respect to horizontal axis after rotation in the x direction, the slope angle on x\y directions is recorded as φ, the slope angle on z direction is recorded as θ, and the calculation is based on the following equations:

acc_x=1 g*sin θ*cosφ;

acc_y=−1 g*sin θ*sinφ;

acc_z=1 g*cos φ;

acc_y/acc_x=−tanφ, then substituting the acc_x, acc_y, acc_z calculated in the step A into the equations, and calculating the slope angle oar x\y directions and the slope angle on z direction.

The processor controls the display according to the calculated slope angle on x\y direction and the calculated slope angle on z direction and changes the display areas in real time. The specific method for changing the display areas by the processor is that making the rotation angle required for the display areas of the display equal to the slope angle on z direction. As shown in FIG. 5, the display areas can be switched from the specified initial display areas 102 to the display areas 102′ corresponding to the rotation angle φ calculated by the processor, and the rotation angle φ is the slope angle θ on z direction, which is calculated from acceleration values acc_x, acc_y, acc_z (known) on x/y/z directions according to the above equations, such that the display areas of the display are enabled to face upwardly or face the user all the time.

The portable terminal in the present embodiment is an annular watch, the specific control method thereof includes:

A. when the acceleration values on three directions x/y/z of the embedded gravity acceleration sensor changes, the gravity acceleration sensor performs A/D conversion and transmits angle and acceleration on three directions x/y/z to the processor inside the watch, and the processor determines whether or not the User rotates his/her wrist or the watch.

B. when it is determined that the user rotates his wrist or the watch, the processor performs the corresponding calculation, calculates the corresponding angle by which the watch rotates, and makes the display areas rotate correspondingly, such that the display areas are enabled to face upwardly or face the user's eyes all the time.

For example, when the processor of the watch detects the changes of three direction x/y/z of the gravity acceleration sensor and the calculated rotation angle falls into the range of 0-180 degrees, the processor determines the rotation direction and angle of the user in real time on the basis of acceleration variation of rotation, and sets the display areas within the range of 0-180 degrees with respect to the gravity acceleration sensor in real time, such that the display areas are enabled to locate at the position absolute 0 degree all the time.

The above embodiments are merely used for illustrate principle and effect of the present invention, not for defining the scope of the present invention. Any person skilled in the art can modify or amend these embodiments without deviating the scope and spirit of the present invention. Therefore, any amendment or modification without deviating the principle and spirit of the present invention will fall into the scope of the claims of the present invention.

1. A portable terminal with controllable display position, comprising: a portable terminal body, a display arranged on the portable terminal body, a processor and a gravity acceleration sensor, the display is a curved surface display or a flexible display with a plurality of display areas, both the display and the gravity acceleration sensor are in communication connection with the processor, and the processor controls the display areas of the display according to data detected by the gravity acceleration sensor.

2. The portable terminal with controllable display position according to claim 1, wherein a memory is arranged on the potable terminal body and the memory is connected to the processor.

3. The portable terminal with controllable display position according to claim 1, wherein the gravity acceleration sensor is connected to the processor via signal line.

4. The portable terminal with controllable display position according to claim 1, wherein the gravity acceleration sensor is connected to the processor via wireless connection.

5. A display method of the portable terminal, comprising:
i) monitoring an orientation change of the terminal in real time by the gravity acceleration sensor arranged inside the portable terminal;
ii) when the change of terminal position is detected, determining the direction and angle of the terminal rotation according to the recorded change value on three directions of the gravity acceleration sensor;
iii) re-determining the center of the display areas on the display of the portable terminal according to the direction and angle of the terminal rotation, and displaying content on the display based on the center of the display areas.

6. The display method of the portable terminal according to claim 5, wherein the step ii) includes following steps:
A. using the gravity acceleration sensor to detect the orientation of the portable terminal, decomposing in real time the gravity acceleration into acceleration on x, y, z directions in three-dimensional space, i.e. acc_x, acc_y, acc_z, and transmitting the detected data to the processor;
B. the processor calculates the status of the gravity acceleration sensor according to the measured data, i.e. calculating slope angle on x\y directions and slope angle on z direction of the gravity acceleration sensor, and determining direction and angle of the rotation.

7. The display method of the portable terminal according to claim 6, wherein in the step B the method of calculating slope angle on x\y direction and slope angle on z direction is: the slope angle on x\y directions is recorded as φ, the slope angle on z direction is recorded as θ, and the calculation is based on the following equations:
acc_x=1 g*sin θ*cos φ;
acc_y=−1 g*sin θ*sin φ;
acc_z=1 g*cos φ;
acc_y/acc_x=−tanφ, then substituting the acc_x, acc_y, acc_z calculated in the step A into the equations, and calculating the slope angle on x\y directions and the slope angle on z direction.

8. The display method of the portable terminal according to claim 7, wherein the rotation angle required for the display areas of the display equal to the slope angle on z direction.
